(19) United States
(12) Patent Application Publication
(10) Pub. No.: US 2009/0205573 A1
(43) Pub. Date: Aug. 20, 2009

(54) ANIMAL FEEDER

(75) Inventor: Alain BRIERE, Valleyfield (CA)

Correspondence Address: Alain Briere, 77 Puruis Street, Valleyfield, QC, J6S 2B9, omitted

(73) Assignee: Alain BRIERE, Valleyfield (CA)

(21) Appl. No.: 12/033,968

(22) Filed: Feb. 20, 2008

(51) Int. Cl. A01K 5/00

(52) U.S. Cl. 119/57.91

(57) ABSTRACT

An animal feeder has a container for being filled with animal feed which is pushed by a platform toward an open end of the container. The open end of the container is very large and thus is not blocked even when used with large feed such as apples. The platform is connected to a screw, which is turned by a motor. The motor is controlled in a timely manner with a programmable timer.

### FIELD OF THE INVENTION

The field of the invention relates to a mechanism for feeding animals, in particular to an animal feeder where feed is pushed toward an open top end of a container.

### BACKGROUND OF THE INVENTION

Animal feeders are widely used to distribute feed to animals in a controlled manner. In some cases, the feeders simply hide the bulk of the feed from the animal so the animal does not attempt to consume all the feed at one time. They typically provide passageways for the feed to fall to the ground whenever the animal eats the feed blocking the passageways. While this provides some protection against the animal eating all the feed at one time, the feed is continuously being fed through the passages by gravity and thus is consumed relatively fast.

Other feeders provided times mechanisms to open and close the passages to timely distribute the feed to the animals. This evenly distributes the feed to the animals thus the amount of feed being consumed can be controlled for purposes such as health or simply to increase the chance the animals will returns to one particular spot.

Prior art distributors rely on gravity to push the feed through the open passages at the bottom of the feeder. While this is convenient for small grains such a wheat and corn, providing large passageways for fruit such as apples and pears become cumbersome and usually tend to get blocked in the mechanism to close the passages unless a very large and heavy mechanism is used.

There is therefore a need for an animal feeder, which does not rely on gravity nor individual passages and can also timely distribute large fruit such as apples and pears as well as grains such as wheat and corn.

### BRIEF DESCRIPTION OF THE DRAWINGS

FIG. 1 is an elevation view of the feeder of the present invention, with the moveable platform at a lower position.

FIG. 2 is an elevation view of the feeder of the present invention with the moveable platform in an intermediate position.

FIG. 3 is a top view of a first embodiment of the feeder of the present invention with the roof removed.

FIG. 4 is a top view of a second embodiment of the feeder of the present inventions with the roof removed.

FIG. 5 is a partial section of the platform and the screw taken along 5-5 as shown in FIG. 1.

FIG. 6 is an elevation view of a second embodiment of the present invention.

FIG. 7 is a cross-section of an alternative attachment between the motor and the screw.

FIG. 8 is a cross section of an elevation view of a third embodiment of the present invention.

### SUMMARY OF THE INVENTION

It is an object of the present invention to have an animal feeder with a container having sides, a closed bottom surface and an open top end, a screw passing through the bottom surface and extending toward the open top end of the container, a platform disposed within the container, the platform being threaded with the screw to move relative to the container, a motor connected to the screw to effect a rotation of the screw, wherein rotation of the screw forces the platform to travel within the container between the closed bottom surface and the open top end.

It is yet another object of the present invention to have a sweeper fixed to a top end of the screw, wherein the sweeper rotates with respect to the container to push feed over the top end of the container.

Yet another object of the present invention comprises a programmable timer, the programmable timer is connected with the motor to selectively open and close a circuit between the motor and a battery.

### DETAILED DESCRIPTION OF THE PREFERRED EMBODIMENTS

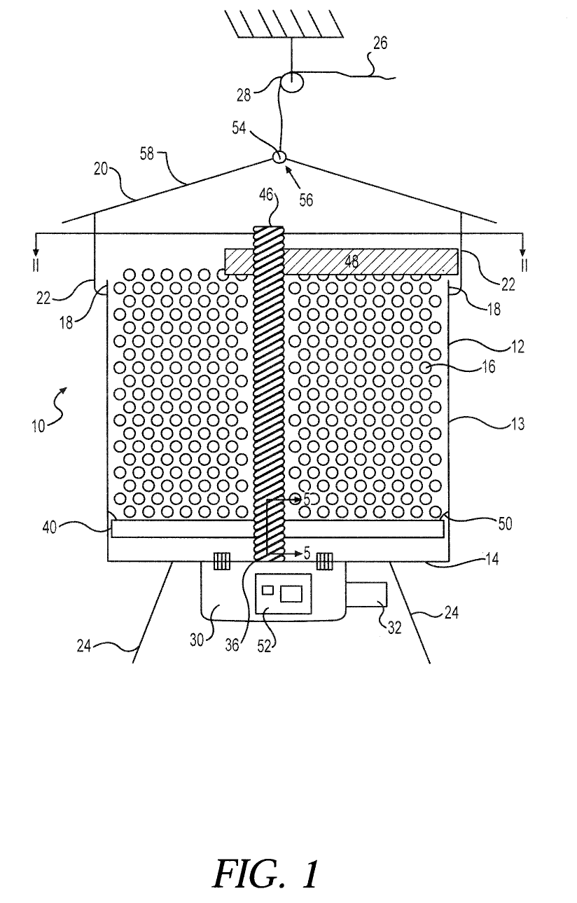

FIG. 1 shows an animal feeder 10 having an outer wall 12 and a bottom 14 forming an open ended container 13 which will hold animal feed 16 such as apples, pears, wheat, corn etc.

The top end or edge 18 of the outer wall 12 is open such that the feed 16 may pass over the edge 18 and fall to the ground.

A roof 20 is attached to the outer wall 12 by two or more stays 22. Preferably stays 22 are made from a small diameter wire or a narrow structure so the feed 16 is not prevented from falling over the edge 18 of the outer wall 12. Roof 20 helps prevent the container 13 from filling with rain, snow or falling leaves. It is contemplated that two portions of the roof 20 could be hinged together by hinge 54 along its apex 56 so that a portion of the roof 20 may be lifted to facilitate filling the container 13. It is contemplated that the roof 20 could be omitted without departing from the scope of the present invention.

Feeder 10 could be rested directly on the ground by legs 24 or alternatively the feeder 10 could be lifted above the ground using a rope 26 and pulley 28 or other mechanism. Rope 26 could be attached to roof 20 or directly to the container 13.

A motor 30 and a battery pack 32 are attached to the bottom 14 of the container 13. For ease of assembly, motor 30 and battery pack 32 are attached to the outside of the container 13. These parts could also be attached within the container as well.

The motor 32 is preferably fixed to the container 13 so not relative motion is permitted therebetween. Attached to the motor 30 is a screw or worm gear 34. Screw 34 extends from the motor 30, through an aperture 36 in bottom 14 of the container 13, toward the tope edge 18 of container 12. Preferably, motor 30 and screw 34 are centered with respect to the container bottom 14.

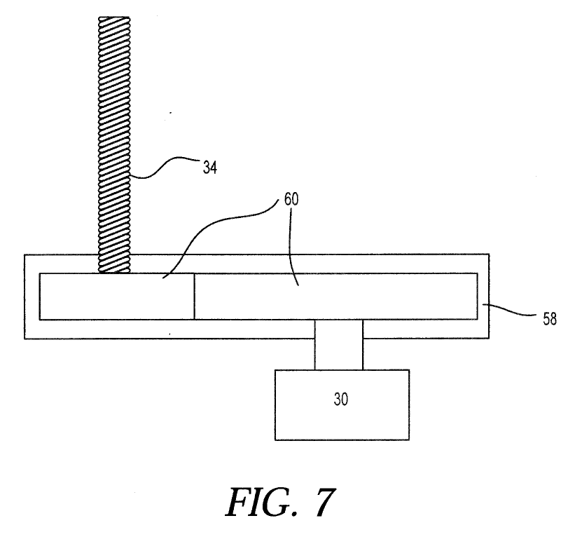

FIG. 7 shows an alternative connection between motor 30 and screw 34. A gear reduction mechanism 58 is supplied between the motor 30 and screw 34. Gear reduction mechanism 58 contains one or more gears 60. It is contemplated that the gear reduction mechanism 58 could be used to reduce the on-time of the motor 30 so as to require less power from the battery or reduce the necessary torque output required from motor 30 to turn screw 34 which will require less output from the motor 30 and also prolong battery life.

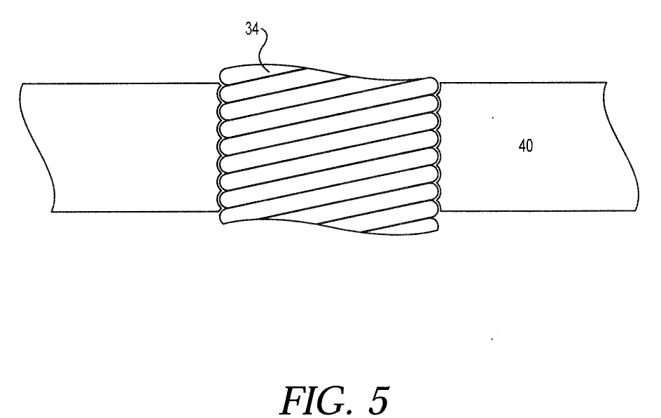

Returning to FIG. 1, a moveable platform 40 is connected to the screw 34 such that platform 40 moves along the screw 34 when motor 30 turns screw 34. It is contemplated that screw 34 could mate with platform 40 with co-operating threads as shown in FIG. 5.

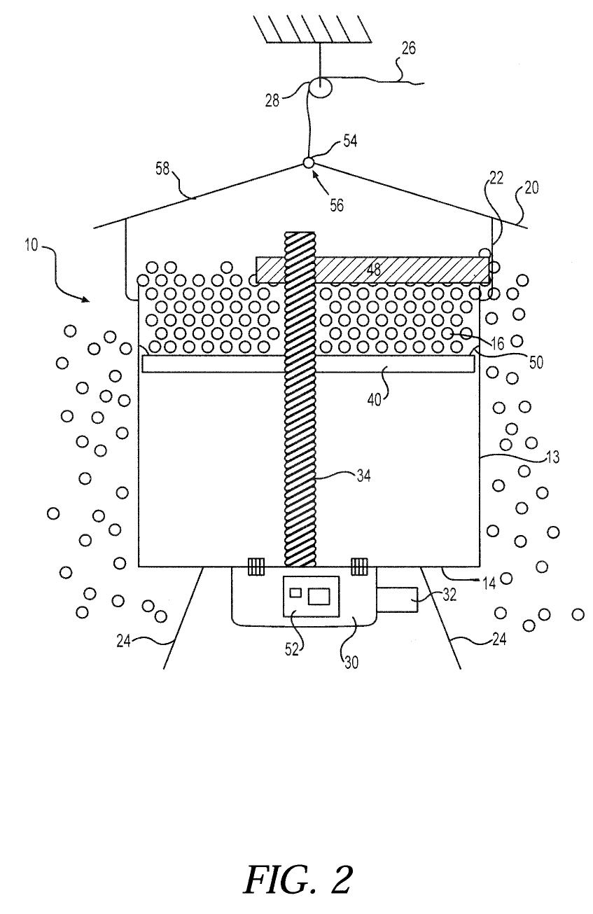

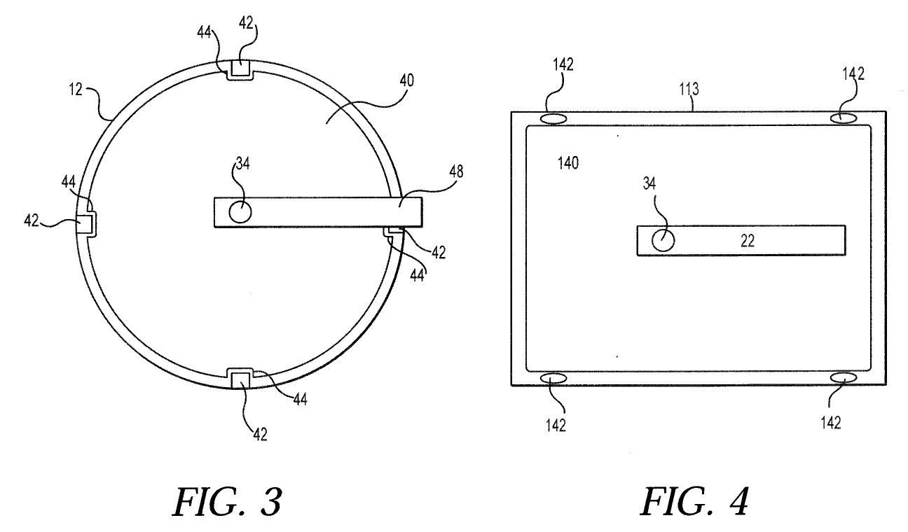

To prevent platform 40 from rotating with the screw 30 during operation, platform 40 is equipped with one or more slots 44. As best seen in FIG. 3, slide bars 42 are attached to the inside surface of outer wall 12 such that when assembled the slots 44 co-operate with the slide bars 42 so platform 40 can slide up and down along slide bars 42 while being prevented from rotating with screw 34 thus forcing the platform to raise or lower inside container 13. With reference to FIG. 4, a square or rectangular container 113 and platform 140 could be used instead of the circular ones shown in FIGS. 1 and 2. In this case, slide bars 142 could be used to simply prevent the jamming between platform 140 and container 113. The non-circular shape of the platform 140 and container 113 themselves would prevent relative rotation therebetween.

Experimentation has also shown that slide bars 42 and slots 44 can be removed and the friction between the feed 16, the container 13 and the platform 40 is sufficient to prevent platform 40 from rotating while moving upward.

With reference to FIG. 2, attached to an upper end 46 of the screw 34 is a sweeper 48. Sweeper 48 is fixed to screw 34 such that it rotates with screw 34. As the feed 16 is being pushed upward by platform 40 toward edge 18 of container 13, sweeper 48 pushes the feed 16 toward and over edge 18 so that it will fall to the ground and avoid possibly hitting and jamming under roof 20.

As would be appreciate, when using feeder 10 without the roof 20, the sweeper may not be necessary since the feed will automatically fall over the edge 18 at a certain height. To ensure that most of the feed is pushed over the edge once the platform has reached its maximum height; it is preferable to use a sweeper 48. Sweeper 48 is preferably placed at a height equal to the height of the container 13, and may extend radially away from the screw 40 to the container outer wall 12 and possibly beyond. Although only one sweeper 48 is shown, multiple sweepers, placed at different angles from each other, can be used.

To prevent small feed such as wheat or corn from falling between the platform 40 and container wall 12, a seal 50 can be placed around the periphery of platform 40 to slidingly engage the container wall 12. Again, if platform 40 is snugly fitted within the container wall 12 such that only vertical movement of the platform is possible, the snug fit may ensure that no small grains will fall between the platform 40 and the container wall 12 and thus seal 50 can be omitted.

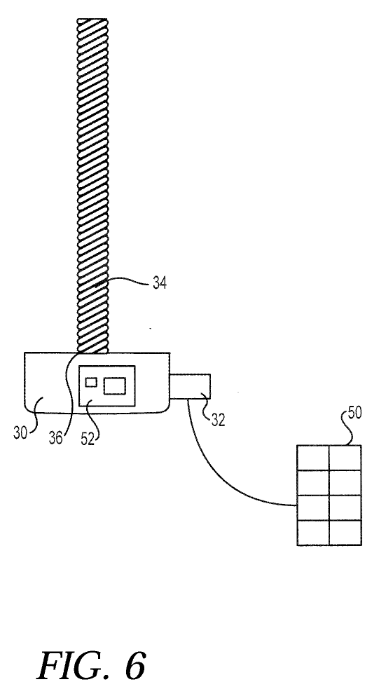

With reference to FIG. 6. Because most feeders are used away from electrical outlets, the battery 32 could be attached to a solar panel 50 to avoid having to remove the battery for charging. A programmable timer 52 is connected between the battery 32 and the motor 30 to open and close the current flow therebetween as desired. Timer 52 can be of any well-known type and thus will not be described in further detail. Timer 52 allows the user to set the time of day and duration the feed is to be distributed from the feeder 10.

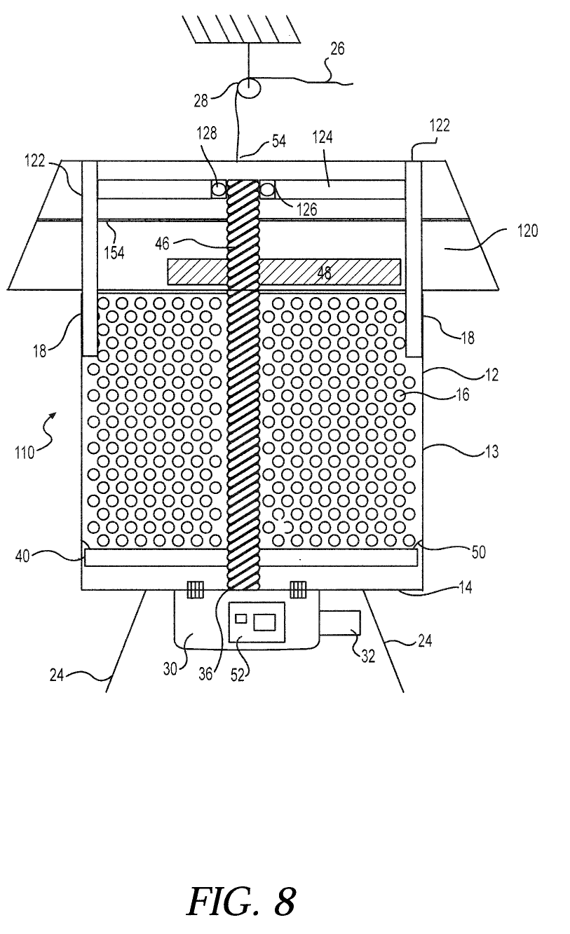

FIG. 8 shows an alternative embodiment of the present invention. Like elements are numbered the same and will not be further described. Feeder 110 has a roof 120 attached to the top edge 18 of container 13 by stays 122. A cross member 124 spans between two opposing stays and has an aperture 126 to accept screw 34. A ball bearing 128 can be provided within aperture 126 such that screw 34 can be vertically aligned to prevent any misalignment when attaching the motor 30 to the container 13 and thereby causing the platform 40 to bind against the container 13 during operation. A hinge 154 is again placed in a portion of the roof 120 so that a portion of the roof can be lifted out-of-way to ease filling of the container 13.

Although V or tent-shaped roofs are shown, it is contemplated that conical-shaped roofs could also be used without departing from the scope of the present invention.

### Operation of the Feeder

The operation of the feeder 10 of the present invention will now be described. Before filling container 13 with feed, the motor 32 should be operated in a first direction so that platform 40 is lowered or raised to a desired height such as that shown in FIG. 1. Feed 16 is then emptied into container 13 through its open end. To facilitate filing, one may remove roof 20, open the hinged portion 58, or simply fill the feed 16 through the stays 22. The motor 32 is then operated in a second direction such that the platform 40 is raised so that the feed 16 is level with the top edge 18 of the container 13 if not done so during filling.

Timer 52 is then programmed so that the feed 16 is distributed at the desired time and rate. It is preferred to have tested and calculated before programming the speed at which the platform 40 is raised within the container 13 so that the correct timing and rates are made.

With reference to FIG. 2. Once the programmed time is reached, the timer will close the circuit between the battery 32 and the motor 30 such that the screw 34 will rotate for the desired amount of time. During this time, platform 40 will move toward the top edge 18 of container 13 pushing the feed 16 toward sweeper 22 where the feed 16 is swept over edge 18 onto the ground for the animals to eat. Once the desired on-time has passed, the timer 52 will open the circuit and the motor 30 will stop turning thus the feed 16 will stop falling over the edge 18.

As should be appreciated, feeder 10 can be used with small grains as well as large fruits without modifications. Unlike the prior art there are no passages or doors to open or close which could get blocked and prevent further distribution.

Although this aspect of the invention has been described with respect to the embodiment illustrated in FIGS. 1-8, various alternatives may be used without departing from the scope of the invention. For example, the game feeder may be constructed of plastic, metal, or wood, or a combination thereof. The game feeder may be constructed in any shape desired and can be camouflaged. It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. An animal feeder comprising:
a container having a sidewall, a closed bottom surface and an open end;
a screw passing through the bottom surface and extending toward the open end of the container;
a platform disposed within the container, the platform being threaded with the screw to move relative to the container;
a battery-powered motor connected to the screw to effect a rotation of the screw,
wherein rotation of the screw forces the platform to travel within the container between the closed bottom surface and the open end.

2. The animal feeder of claim 1, further comprising:
A sweeper fixed to the screw, wherein the sweeper rotates with respect to the container to push feed over the open end of the container.

3. The animal feeder of claim 2, further comprising a roof, the roof being connected to the open end of the container with at least one stay.

4. The animal feeder of claim 2, wherein the platform has an outer periphery adjacent an inner surface of the container wall and a seal attached to the outer periphery of the platform in sliding contact with the container wall to prevent feed from falling between the platform and the container wall.

5. The animal feeder of claim 3, wherein the roof further comprises a hinged portion, which can be lifted to open the container.

6. The animal feeder of claim 1, further comprising a cross member connected to the at least one stay, the cross member having an aperture for receiving a top end of the screw, the aperture aligning the screw with the bottom surface of the container such that the screw is vertical.

7. The animal feeder of claim 6, further comprising a roof covering the container, the roof having a hinge so that a portion of the roof can be lifted to gain access to the container for filling the container.

8. The animal feeder of claim 1, further comprising a gear reduction mechanism connected between the motor and the screw.

9. The animal feeder of claim 7, further comprising a ball bearing within the aperture to provide substantially frictionless rotation between the screw and the cross member.
